(19) United States
(12) Patent Application Publication
(10) Pub. No.: US 2008/0191460 A1
(43) Pub. Date: Aug. 14, 2008

(54) Transaction card assembly with shaped scratch-off layer

(75) Inventor: Stuart Blank, Wayland, MA (US)

Correspondence Address: WOLF GREENFIELD & SACKS, P.C., 600 ATLANTIC AVENUE, BOSTON, MA, 02210-2206, US

(73) Assignee: Arthur Blank & Company, Inc., Boston, MA (US)

(21) Appl. No.: 11/704,411

(22) Filed: Feb. 9, 2007

(51) Int. Cl. B42D 15/00

(52) U.S. Cl. 283/72

(57) ABSTRACT

A transaction card assembly may include a scratch-off layer that conceals a PIN or other security-sensitive information. The scratch-off layer may have an irregular shape that represents text, a logo, a trademark, a product offered by an issuer of the card, or a service offered by an issuer of the card

### FIELD OF THE INVENTION

This invention relates to transaction cards.

### BACKGROUND OF THE INVENTION

Transaction cards, such as credit and debit cards, membership cards, promotional cards, e.g., frequent flyer cards, identification cards and the like, are widely used. Such transaction cards may include a variety of different indicia to identify the card, the individual using the card, an associated transaction account, such as a credit card, gift card or telephone calling card account, or other features. The indicia may include a string of printed alphanumeric characters, a bar code, an encoded magnetic strip attached to the card, an embossing, a hologram or other security feature, printed logos, and so on.

Some transaction cards include a scratch-off layer or other removable feature that is used to conceal security-sensitive information, such as a personal identification number (PIN) or other feature. For example, some gift cards, telephone cards or other cards require the use of a PIN to activate an account associated with the card at or after the time of purchase. That is, after purchasing such a card, the purchaser/issuee of the card may be required to telephone a particular number and type in an account code and/or the PIN to activate the card's account. In another context, the PIN on a card, such as a gift card, may be required for use in some circumstances, like making purchases over the Internet or by telephone. To help prevent theft of the account, a scratch-off label may be applied on the card over the PIN so that only the card owner can first discover the PIN. The scratch-off layer is typically arranged so that, once it is removed or otherwise disturbed to reveal the PIN, the scratch-off layer cannot be replaced and injury to the layer is readily discoverable. Thus, a purchaser of the card may be able to detect whether the card's PIN has been compromised before purchase of the card, and if the scratch-off layer has been disturbed, choose another card for purchase. Typically, such scratch-off layers are applied to the card in a rectangular shape over a printed PIN.

### SUMMARY OF INVENTION

The inventor(s) have discovered that providing a shaped scratch-off layer for concealing a PIN or other security-sensitive information on a transaction card may lend additional interest to the card for a purchaser/issuee, and thus provide a competitive benefit to the card issuer. In addition, the shaped scratch-off layer may draw attention to the layer, increasing the likelihood that a purchaser/issuee or other person will inspect the scratch-off layer to determine if the security-sensitive information has been compromised in whole or part. In some embodiments, a shaped scratch-off layer may help to enhance security of the card, e.g., helping to identify fraudulently made, but otherwise authentic looking, cards.

In one aspect of the invention, a transaction card assembly includes a transaction card constructed and arranged for use in a transaction by an issuee of the transaction card. The card may have opposed substantially planar sides, e.g., like that found in a standard credit card. Indicia may be formed on at least one of the sides of the card, and may include a personal identification number (PIN) useable in a transaction regarding the transaction card. The PIN may be a security code, e.g., used in initiating a card's account after purchase or used in accessing an account, such as when obtaining prepaid telephone services, or may be a card verification value like that found on some credit cards, or another similar feature. A scratch-off layer may be formed over part of the PIN on the side of the card, with the scratch-off layer arranged to conceal the PIN from view and allow a user to remove the scratch-off layer to reveal the PIN without damaging the card. For example, a user may remove the scratch-off layer by scratching with a fingernail, coin or other. The scratch-off layer may be formed in an irregular shape on the card to represent a logo (whether or not associated with the issuer and/or its products or services), a trademark, a product offered by an issuer of the card, or a service offered by an issuer of the card.

In another aspect of the invention a method for forming a transaction card assembly includes providing a card constructed and arranged for use in a transaction by an issuee of the transaction card, and forming indicia on at least one of the planar sides of the card. The indicia may include a personal identification number (PIN) useable in a transaction regarding the transaction card. A scratch-off layer may be formed over part of the PIN on the side of the card to conceal the PIN from view, and may be arranged to allow a user to remove the scratch-off layer to reveal the PIN without damaging the card. The scratch-off layer may be formed in an irregular shape on the card to represent a logo, a trademark, a product offered by an issuee of the card, or a service offered by an issuee of the card.

In another aspect of the invention, a transaction card assembly includes a card constructed and arranged for use in a transaction by an issuee of the transaction card, and indicia attached to the card. The indicia may include security-sensitive information useable in a transaction regarding the transaction card, such as a PIN. A scratch-off layer may be formed to conceal part of the security-sensitive information attached to the card, and allow a user to remove the scratch-off layer to reveal the security-sensitive information without damaging the card. The scratch-off layer may be formed in an irregular shape on the card to represent a logo, a trademark, a product offered by an issuer of the card, or a service offered by an issuer of the card.

These and other aspects of the invention will be apparent from the following description and claims.

### BRIEF DESCRIPTION OF THE DRAWINGS

Illustrative embodiments incorporating aspects of the invention are described below with reference to the following drawings, in which like numerals reference like elements, and wherein:

FIG. 1 shows an illustrative embodiment of a transaction card assembly having a shaped scratch-off layer;

FIGS. 2-6 show examples of shaped scratch-off layers in accordance with aspects of the invention;

FIGS. 7 and 8 show examples of a scratch-off layer having multiple shaped portions in accordance with aspects of the invention;

FIGS. 9 and 10 show examples of a scratch-off layer having multiple similarly shaped portions in accordance with aspects of the invention;

FIG. 11 shows a scratch-off layer including printed text in accordance with an aspect of the invention; and

FIG. 12 shows a schematic view of a scratch-off layer application process in accordance with an aspect of the invention.

### DETAILED DESCRIPTION

It should be understood that aspects of the invention are described with reference to the figures which depict illustrative embodiments. The illustrative embodiments described below are not intended to show all aspects of the invention, but rather are used to describe a few illustrative embodiments. Thus, the claimed inventions are not intended to be construed narrowly in view of the illustrative embodiments.

As discussed above, transaction cards are widely used for a variety of different purposes, such as for credit and debit account purchases, tracking member activity (e.g., tracking frequent flyer activity), for gift-certificate purchases, opening hotel room doors, verifying a person's identity, and so on. Vendors issuing transaction cards for tracking member activity typically wish to ensure that issuees of a card (i.e., purchasers or other appropriate owners/users of a card) receive whatever value is appropriately associated with the transaction card. As one example, a vendor may wish to issue a gift card, a prepaid telephone card or other prepaid card that entitles the bearer to a specified amount of purchase or telephone use credit. As with any of the embodiments described herein, the transaction card may be used, for example, as a credit or debit card, a membership identification card, an account identification card, a gift card, a prepaid telephone card, and so on.

In some cases, a transaction card may include security-sensitive information in addition to other indicia provided with a transaction card. (Indicia as used herein refers to alphanumeric text, graphics, logos, trademarks, images, colors, electronic chips or other similar devices, electrical contacts for electronic devices in or on the card, magnetic strips, bar codes, and/or any other features included on a card, however formed.) The security-sensitive information may include alphanumeric text (such as a PIN or other), a logo, image, or any other suitable information. For example, the security-sensitive information may be a discount percentage (e.g., 10% off) that the issuee of the card may receive on a first purchase, a bonus amount that is added to the card's account value at time of activation, or other. Thus, the security-sensitive information is not limited to a PIN or similar notwithstanding the following description of illustrative embodiments.

In accordance with one aspect of the invention, to distinguish their products, i.e., goods or services, offered in connection with a transaction card assembly, an issuer of a transaction card may include a shaped scratch-off layer on some portion of a transaction card that has a shape to represent a logo, a trademark, a product offered by an issuer of the card, or a service offered by an issuer of the card. (The “shape” of the scratch-off layer refers herein to the 2-dimensional form of the scratch-off layer on the card.) For example, a product name or representative symbol may be formed by the scratch-off layer used to conceal a PIN or other information on the card. This may result in the shape of the scratch-off layer itself giving a potential customer an impression of the products offered, a source of the products, and/or draw attention to the location of concealed information. This impression may help bring a particular trademark or product to the purchaser's attention, and may induce increased economic activity and/or perceived value in connection with the cards.

FIG. 1 shows an illustrative embodiment of a transaction card 1 that incorporates various aspects of the invention. In accordance with one aspect of the invention, the card 1 includes a scratch-off layer 13 that has an irregular, non-rectangular shape that represents a logo, a trademark, a product offered by an issuer of the card, and/or a service offered by an issuer of the card. (A logo may be, for example, a depiction of an object, shape, text, color, and/or other representation, whether or not the logo is used by the card issuer as a type of trademark or has any other association with the issuer itself or any goods or services provided by the issuer. For example, a scratch-off layer 13 on a card issued by a coffee shop may include a logo that depicts a house, which may not necessarily have any association with the coffee shop or its products/services offered.) If the scratch-off layer 13 represents a trademark, the trademark need not be registered with a government authority, but instead may be any mark to which the user may be entitled trademark rights under state or other government law. In this illustrative embodiment, the scratch-off layer 13 is shaped to resemble a cup, e.g., a product offered by the issuer of the card in this example. The scratch-off layer 13 in this case conceals a PIN printed on the card, but the scratch-off layer 13 may conceal any other suitable security-sensitive information, such as a purchase discount, a bonus amount to be credited to the account, a coupon indication, a lottery or other sweepstakes number, a card account number, etc. For example, in another embodiment in which the card 1 includes its associated account number in a bar code, the scratch-off layer 13 may conceal the bar code, preventing a thief from determining the card's account number unless the scratch-off layer 13 is removed. The scratch-off layer 13 may be removed at the time of purchase, allowing scanning of the bar code and subsequent activation of the account. (Commonly, gift card accounts are inactive (the cards are so-called “dead cards”) until the card is purchased. At or after the time of purchase, the card's account may be activated by scanning the account number, e.g., using a bar code or magnetic strip scanner, and sending the account number to a clearinghouse database to activate the account.)

The scratch-off layer 13 may be arranged to allow for removal, e.g., by scratching with a fingernail or coin, with or without damage caused to the card 1. In this embodiment, the scratch-off layer 13 may be removed without causing damage to the card 1 and to reveal the PIN. Also, any damage caused to the scratch-off layer 13 may be irreversible, and the scratch-off layer 13 may allow for detection of partial damage to the layer 13. Thus, a purchaser of the card can detect, at or before purchase of the card, whether the PIN or other concealed security-sensitive information on the card has been compromised, and if so, choose another card to purchase.

In this illustrative embodiment, the card 1 has a rectangular shape that meets the ANSI and ISO standards of a CR-80 card (e.g., which is about 3.370 inches wide and 2.125 inches high, and has a thickness of about 0.030 inches). Of course, it will be understood that various aspects of the invention may be used with any size, shape, thickness or other configuration of card. Also, aspects of the invention may be used with cards that have attached carriers or other auxiliary portions. For example, U.S. Pat. No. 6,588,658 (incorporated herein by reference in its entirety) describes arrangements that have one or more transaction cards and one or more auxiliary members all attached together as one assembly. Aspects of the invention may be used on the transaction card portions and/or auxiliary card portions of those arrangements in U.S. Pat. No. 6,588,658. For example, in one illustrative embodiment, a gift card assembly may include a CR-80 transaction card and attached auxiliary member. The auxiliary member may include the card's account number and PIN printed on it, and have a scratch-off layer concealing the PIN at the time of purchase. Thus, the issuee of the card may reveal the PIN on the auxiliary member, e.g., for using the card account for online purchases, but retain the auxiliary member and PIN in a safe place (such as at home). Thus, the issuee may help prevent a thief from discovering the card account's PIN when the issuee uses the card at an in-store transaction (which does not require use of the PIN), thereby preventing the thief from later using the card's account and PIN to make unauthorized online or in-store purchases. In this case, the PIN printed on the auxiliary member and the concealing scratch-off layer are said to be associated with and attached to the transaction card, at least at a time prior to the auxiliary member and transaction card portions being separated from each other.

FIG. 1 shows the rear side of the card 1, although various aspects of the invention may be used with the front side of the card 1, and/or both sides of the card. In this illustrative embodiment, the card 1 includes an encoded magnetic strip 11 and a printed bar code 12. The magnetic strip 11 may be encoded with any suitable information, such as the card's associated account number(s), as is common with credit cards, debit cards and automatic teller machine (ATM) cards. The magnetic strip 11 may be heat laminated to the transaction card 1, e.g., in a way to meet current or future ANSI and ISO standards, or may be positioned on the transaction card in other ways. For example, the magnetic strip 11 may be fixed to the transaction card 1 by an adhesive. Use of a magnetic strip that meets ANSI and ISO specifications may be required for specific applications, such as credit card applications where the magnetic strip may be repeatedly read over its lifetime. However, the magnetic strip may be fixed to the transaction card 1 in a less robust way for less demanding applications, such as where the magnetic strip may be read only once or twice over its lifetime. Similarly, the bar code 12 may be formed in any suitable way and may include any suitable information, such as account number(s) or other.

Although in this illustrative embodiment, the card 1 includes machine readable features in the form of a bar code and magnetic strip, it should be understood that the card 1 may include one or more machine readable features in any configuration. For example, a card in accordance with aspects of the invention may have only a magnetic strip 11, only a bar code 12, or may have neither a magnetic strip or bar code. Thus, the card 1 may include any suitable arrangement of machine readable features either of the same type or of different types, e.g., two magnetic strips, a magnetic strip and a bar code, a printed account number, etc. Further, the machine readable features, like any other information on the transaction card 1 may be placed on any suitable side or location of the card 1. The transaction card 1 may include other machine readable features, such as semiconductor devices found in electronic cash cards or smartcards like that described in U.S. Pat. No. 5,971,282. Thus, the transaction card 1 may include any suitable electronic device capable of providing identification information, receiving and processing information or performing other desired transaction functions. The machine readable features may be used to store, obtain, transmit or otherwise handle any type of information, such as text, biometrics information (such as eyescan or fingerprint information) and so on.

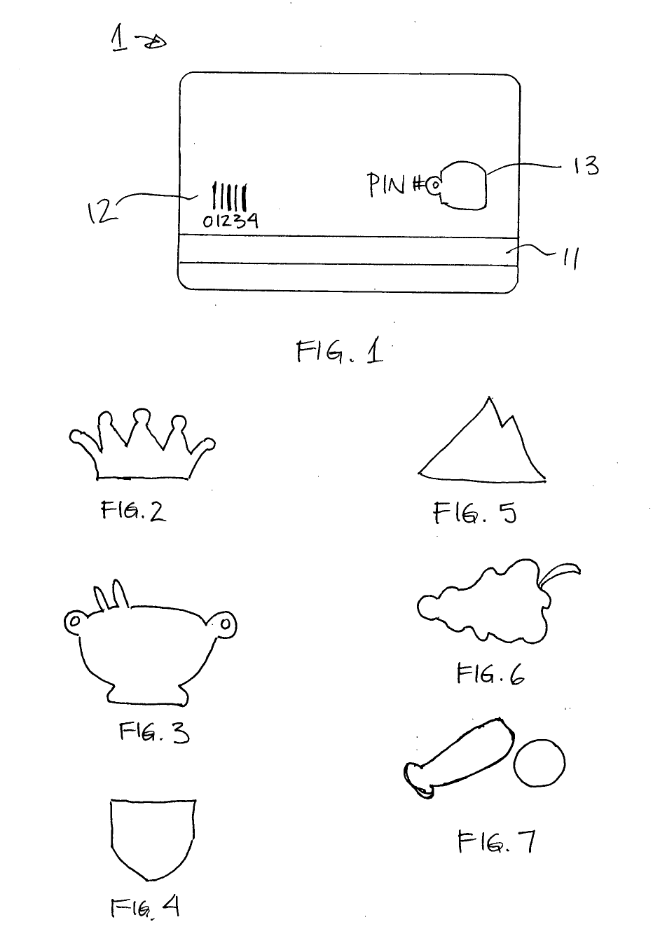

It should be understood that the scratch-off layer 13 may be arranged in any suitable way. For example, the scratch-off layer 13 may be positioned in any suitable location on the card 1, whether the front and/or back side of the card 1. Likewise, the scratch-off layer 13 may obscure any suitable information, whether completely or partially. The shape of the scratch-off layer 13 may be arranged in any way, as shown by way of example in FIGS. 2-6. FIG. 2 shows a scratch-off layer 13 in the shape of a crown (representing a company trademark, for example), FIG. 3 shows a scratch-off layer 13 in the shape of a bowl with utensil handles projection from the upper rim (representing a restaurant logo, or kitchenware store), FIG. 4 shows a scratch-off layer 13 in the shape of a shield (representing a company logo), FIG. 5 shows a scratch-off layer 13 in the shape of a mountain (representing a ski area mountain or outdoor clothing retailer), and FIG. 6 shows a scratch-off layer 13 in the shape of a bunch of grapes (representing a wine, winery, or fruit or other produce). Other arrangements will occur to those of skill in the art, including scratch-off layers 13 in the shape of text.

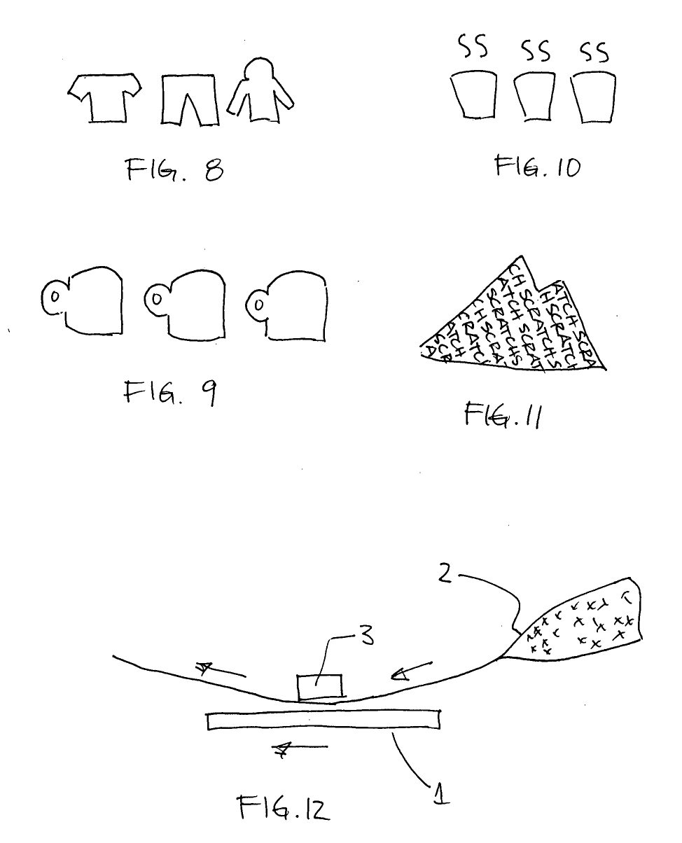

In another aspect of the invention, a scratch-off layer may be arranged to have multiple, separate shapes. For example, as shown in FIG. 7, a scratch-off layer may be arranged to have a bat and ball shape (representing a baseball team, or sports equipment retailer). FIG. 8 shows another embodiment in which the scratch-off layer includes shapes representing a shirt, pants and a jacket (representing a clothing retailer). The scratch-off layer need not include different shapes, but may include two or more shapes that are repeated. For example, FIG. 9 shows a scratch-off layer having repeated mug shapes (representing a restaurant), and FIG. 10 shows repeated cup shapes (representing a coffee retailer). As can be seen in FIG. 10, the scratch-off layer may include multiple components, such as the cup component and “S” shaped lines above the cups, representing steam rising from the cup. Other shape arrangements will occur to those of skill in the art.

In another aspect of the invention, the scratch-off layer may have any suitable text, graphic, logo, trademark or other information printed or otherwise formed on the layer. For example, FIG. 11 shows one illustrative embodiment in which the scratch-off layer 13 has the word “SCRATCH” printed or otherwise formed on it. As will be appreciated, any suitable text, graphic, logo, color, etc. or combination of such elements may be included on the scratch-off layer 13. For example, the scratch-off layer 13 may have the words “SCRATCH” repeated over most of the layer 13, and have a single indication of “PIN BELOW” or similar indicating that a PIN is concealed under the layer 13. In another embodiment, the card issuer's initials, logo or trademark may be repeated over most of the layer 13, and a single indication of “SCRATCH HERE” may be provided to prompt an issuee of the card to remove the scratch-off layer 13. Alternately, the layer 13 may have the words “SCRATCH” repeated throughout along with a background image of coffee beans or other item “behind” the “SCRATCH” text. Accordingly, the scratch-off layer 13 itself may carry any suitable text, logo, trademark, product offered by an issuer of the card, or service offered by an issuer of the card.

The scratch-off layer 13 may be formed on the card 1 in any suitable way. For example, layers 13 may be preformed in a desired shape and then applied to the card 1 like in some label application processes. In such an embodiment, the pre-shaped scratch-off layers may be carried on a backing material, such as a continuous web, and applied from the backing onto the web. In another embodiment, the scratch-off layer may be sprayed, roll coated or otherwise applied to the card in a liquid or powder form, and then dried, cured or otherwise processed to form a suitable scratch-off layer 13. In yet another embodiment, scratch-off layer material may be provided in an “unshaped” configuration on a sheet or web, and then applied by thermal transfer or other suitable means in the desired shape. For example, as shown schematically in FIG. 12, a web or ribbon of material 2 may include a carrier portion or release layer that has the scratch-off layer material attached. The carrier portion may be positioned on top of the scratch-off layer material in this example so that the scratch-off layer material may be positioned immediately adjacent a card 1. The web 2 may be moved along with the card 1, which may be moved on a conveyor belt or other suitable transport device. A printhead 3 may contact the carrier or release layer and interact with the web 2 so that selected portions of the scratch-off layer material are transferred to the card 1. For example, the printhead 3 may include a plurality of relatively small thermal elements that may be rapidly heated and cooled, e.g., by electrical resistance heating. When a suitably heated element contacts the web 2, a portion of the scratch-off material under the thermal element may be transferred to the card 1, in a manner similar to the way a dot matrix printer operates to form a printed image on a sheet of paper. One device suitable for forming scratch-off layers in suitable shapes on transaction cards is the Maxsys Card Issuance System sold by Datacard Group of Minnetonka, Minn. This device is capable of forming scratch-off layers in resolutions at 300 dots per inch (dpi), although any other suitable resolution may be used. Scratch-off layers of desired shapes may be produced by providing a desired image file to the machine, which then controls the thermal transfer printhead accordingly to form scratch-off layers of the indicated shape on cards.

The scratch-off layer may be formed so as to be opaque, translucent and/or transparent, at least in part. Also, the scratch-off layer may be made of one or more layers of material, such as an adhesive layer for adhering the layer to a card, an colorant or other layer, e.g., to make the layer opaque, and a printed layer, e.g., to provide printed text. Any suitable arrangement for the scratch-off layer may be used.

In another aspect of the invention, a odor producing agent may be incorporated into the scratch-off layer 13 on a card 1. Accordingly, when the scratch-off layer 13 is removed partially or completely from the card 1, a desired odor may be released. The odor may be associated with the goods or services of the issuer of the card, such as a coffee aroma for a gift card to a coffee outlet, and so on.

In another aspect of the invention, a scratch-off layer may be formed in random, or pseudorandom locations on a card. This aspect of the invention may be used for security-related purposes. For example, a card may have several different PIN numbers printed on it in different locations on the card. During manufacture, a scratch-off layer 13 may be randomly or pseudorandomly located on the card, concealing one of the several PIN numbers. The relationship of the location of the scratch-off layer 13 and the associated, concealed PIN may be stored by the manufacturer, and used during later administration of the card account. Such an approach may make the fraudulent use of the card and account more difficult. For example, if a thief attempts to use the card for a purchase that requires the PIN, the thief will have to pick one of the PINs on the card to employ. However, an incorrect PIN selection may temporarily lock the account, preventing the thief from attempting to use the account with another PIN. To activate the account, the registered owner of the card and account may be contacted, e.g., by telephone or email, requesting that the owner re-activate the account.

In another aspect of the invention, scratch-off layers 13 may be applied to a card in a variable way to enable the detection of fraudulent cards or otherwise enhance security. For example, a card manufacturing apparatus may be arranged to apply ten different scratch-off layer shapes, such as those shown in FIGS. 1-10. The manufacturing equipment may randomly apply differently shaped scratch-off layers 13 to different cards, at the same time storing information regarding the shape of the scratch-off layer 13 on each card (such as by associating the scratch-off layer shape to the account number on the card). Accordingly, a maker of fraudulent cards having the same account numbers as the authentic cards would have to either inspect each of the authentic cards or gain access to the scratch-off layer shape/account number information to be able to accurately reproduce the unique combination of scratch-off layer shape and account number for each card. This may make the detection of fraudulent cards easier, since simple comparison of the scratch-off layer shape and account number need only be done to verify at least one aspect of the card's authenticity.

In another embodiment, rather than using single different scratch-off layer shapes on different cards, the combination of different shapes may be varied on cards. For example, one card may have the combination of shapes as shown in FIG. 8, i.e., “shirt,” “pants” and “jacket.” On another card, the combination of “shirt,” “pants” “skirt” may be used, and so on. Moreover, the order of the shapes on each card may be varied as well. The shape combination information for each card may be stored, e.g., in association with the card's account number, to allow for later authenticity checks of cards. The variation of shapes may be defined in advance, i.e., before cards are made, may be random, or may be pseudorandom. One example of a pseudorandom variation of scratch-off layer shapes is where the card's PIN, account number, a checkdigit, or other feature of the card may be used as a seed to generate a scratch-off layer shape combination, e.g., using an encryption algorithm. For example, the manufacturing apparatus may use a card's PIN as a seed to generate a value using an encryption algorithm. The generated value may represent a particular scratch-off layer shape, that is then applied to the card. Accordingly, later check of the authenticity of scratch-off layer shapes on a card may be done without reference to stored shape/account number information. Instead, a person making the check may use the account number, PIN or other seed to generate the value used to determines the shape combination that should be present on the card, and then check to verify that the appropriate shape combination is present. It will be understood that such an approach may be used to determine single scratch-off layer shapes in the embodiment above in addition to determining shape combinations.

While aspects of the invention have been described in conjunction with specific embodiments thereof, it is evident that many alternatives, modifications, and variations will be apparent to those skilled in the art. Accordingly, embodiments incorporating aspects of the invention as set forth herein are intended to be illustrative, not limiting. Various changes may be made without departing from the spirit and scope of the invention.

1. A transaction card assembly comprising:
a transaction card constructed and arranged for use in a transaction by an issuee of the transaction card, the card having opposed substantially planar sides;
indicia formed on at least one of the sides of the card, the indicia including personal identification number (PIN) useable in a transaction regarding the transaction card;
a scratch-off layer formed over part of the PIN on the side of the card, the scratch-off layer being arranged to conceal the PIN from view and allow a user to remove the scratch-off layer to reveal the PIN without damaging the card,
wherein the scratch-off layer is formed in an irregular shape on the card to represent a logo, a trademark, a product offered by an issuer of the card, or a service offered by an issuer of the card.

2. The card assembly of claim 1, wherein the scratch-off layer forms the shape of a logo.

3. The card assembly of claim 1, wherein the scratch-off layer forms the shape of a trademark.

4. The card assembly of claim 1, wherein the scratch-off layer forms a shape representing a product offered by an issuee of the card.

5. The card assembly of claim 1, wherein the scratch-off layer forms a shape representing a service offered by an issuee of the card.

6. The card assembly of claim 1, wherein the transaction card is a prepaid card, and the PIN is required for use of an account associated with the prepaid card in defined circumstances.

7. The card assembly of claim 1, wherein the card has a CR-80 configuration.

8. The card assembly of claim 1, wherein the scratch-off layer includes a plurality of repeated irregular shapes.

9. The card assembly of claim 1, wherein the scratch-off layer includes a plurality of irregular shapes, wherein each of the irregular shapes represents a different logo, trademark, product offered by an issuee of the card, or service offered by an issuee of the card.

10. The card assembly of claim 1, wherein the scratch-off layer includes text formed on the scratch-off layer.

11. The card assembly of claim 10, wherein the text formed on the scratch-off layer is repeated a plurality of times.

12. The card assembly of claim 1, wherein the scratch-off layer includes an odor agent that is released when the scratch-off layer is at least partially removed from the card.

13. A method for forming a transaction card assembly, comprising:
providing a card constructed and arranged for use in a transaction by an issuee of the transaction card, the card having opposed substantially planar sides;
forming indicia on at least one of the sides of the card, the indicia including a personal identification number (PIN) useable in a transaction regarding the transaction card; and
forming a scratch-off layer over part of the PIN on the side of the card to conceal the PIN from view, the scratch-off layer being arranged to allow a user to remove the scratch-off layer to reveal the PIN without damaging the card,
wherein the scratch-off layer is formed in an irregular shape on the card to represent a logo, a trademark, a product offered by an issuee of the card, or a service offered by an issuee of the card.

14. The method of claim 13, wherein the PIN is formed by printing on the card.

15. The method of claim 13, wherein the step of forming the scratch-off layer includes:
transferring a portion of a sheet material to the card via a thermal print head.

16. The method of claim 13, wherein the scratch-off layer forms the shape of a logo.

17. The method of claim 13, wherein the scratch-off layer forms the shape of a trademark.

18. The method of claim 13, wherein the scratch-off layer forms a shape representing a product offered by an issuee of the card.

19. The method of claim 13, wherein the scratch-off layer forms a shape representing a service offered by an issuee of the card.

20. The method of claim 13, wherein the transaction card is a prepaid card, and the PIN is required for use of an account associated with the prepaid card in defined circumstances.

21. The method of claim 13, wherein the card has a CR-80 configuration.

22. The method of claim 13, wherein the step of forming the scratch-off layer includes:
forming a plurality of repeated irregular shapes.

23. The method of claim 13, wherein the step of forming the scratch-off layer includes:
forming a plurality of irregular shapes, wherein each of the irregular shapes represents a different logo, trademark, product offered by an issuee of the card, or service offered by an issuee of the card.

24. The method of claim 13, wherein the scratch-off layer includes text formed on the scratch-off layer.

25. The method of claim 24, wherein the text formed on the scratch-off layer is repeated a plurality of times.

26. The method of claim 24, wherein the step of forming the scratch-off layer includes:
transferring a portion of a sheet material to the card via a thermal print head, and wherein the text on the scratch-off layer is formed on the sheet material before the portion of the sheet material is transferred to the card.

27. The method of claim 13, wherein the scratch-off layer includes an odor agent that is released when the scratch-off layer is at least partially removed from the card.

28. A transaction card assembly comprising:
a card constructed and arranged for use in a transaction by an issuee of the transaction card, the card having opposed substantially planar sides;
indicia attached to the card, the indicia including security-sensitive information useable in a transaction regarding the transaction card;
a scratch-off layer formed to conceal part of the security-sensitive information attached to the card, the scratch-off layer being arranged to conceal the security-sensitive information from view and allow a user to remove the scratch-off layer to reveal the security-sensitive information without damaging the card,
wherein the scratch-off layer is formed in an irregular shape on the card to represent a logo, a trademark, a product offered by an issuer of the card, or a service offered by an issuer of the card.
